(19) United States
(12) Patent Application Publication
(10) Pub. No.: US 2019/0141958 A1
(43) Pub. Date: May 16, 2019

(54) MULTI-PURPOSE LEASH WITH INTEGRAL DEFENSE SPRAY ALL IN ONE

(71) Applicant: Landon Price, Indianapolis, IN (US)

(72) Inventor: Landon Price, Indianapolis, IN (US)

(21) Appl. No.: 16/193,548

(22) Filed: Nov. 16, 2018

Related U.S. Application Data
(60) Provisional application No. 62/587,163, filed on Nov. 16, 2017.

(51) Int. Cl. A01K 27/00; F41H 9/10

(52) U.S. Cl. CPC A01K 27/008; F41H 9/10; A01K 27/004

(57) ABSTRACT

A multi-purpose self-defense leash includes a housing having a first section and a second section. Disposed within the first section is a defensive spray canister. Associated with the spray canister is a safety button that is adapted to selectively activate the spray canister. Disposed within the second section is a retractable leash that is wrapped around a spring loaded spool. A leash control button is positioned to selectively engage the spool to prevent rotation of the spool.

### CROSS REFERENCE TO RELATED APPLICATION

This application claims the benefit of the priority of U.S. Provisional Application No. 62/587,163 filed Nov. 16, 2017, the contents of this application is hereby incorporated by reference in its entirety.

### BACKGROUND OF THE INVENTION

The invention relates generally to pet accessories and in particular to a leash with an integral defensive spray. When walking their pets, pet owners are vulnerable to mugging and other types of street crimes. The pet may also be vulnerable to attack by another pet. A retractable pet leash, featuring an integral defensive spray canister, would provide the security and peace of mind that is desired in such situations. The leash retracts into an enclosed spool, using a mechanism that is well known in the art, allowing the pet to run at a comfortable distance away from the user with the convenience of being able to control the pet. An inner spring mechanism keeps the leash under slight tension. The handle provides a soft, flexible grip for comfort during long walks. The device also features a top mounted defensive spray canister, containing a defensive aerosol spray such as pepper spray. If a criminal or stray pet approaches, the user switches the safety lock and presses the spray button on the canister. The bottom of the enclosure features a spool of plastic bags for picking up pet waste, and may also feature a built-in flashlight.

An objective of the present invention is to provide an animal leash that performs multiple functions.

Another objective of the present invention is to provide a leash capable of providing self-defense.

These and other objectives will be apparent to those having skill in the art based upon the following written description, drawings, and claims.

### SUMMARY OF THE INVENTION

Accordingly, the invention is directed to a leash with an integral defensive spray. The leash retracts into an enclosed spool, using a mechanism that is well known in the art, allowing the pet to run at a comfortable distance away from the user with the convenience of being able to control the pet. An inner spring mechanism keeps the leash under slight tension. The handle provides a soft, flexible grip for comfort during long walks. The device also features a top mounted defensive spray canister, containing a defensive aerosol spray such as pepper spray. The bottom of the enclosure features a bag spool which dispenses plastic bags for picking up pet waste, and may also feature a built-in flashlight, Taser, camera, gun or the like.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

FIG. 1 is a side view of a multi-purpose leash;

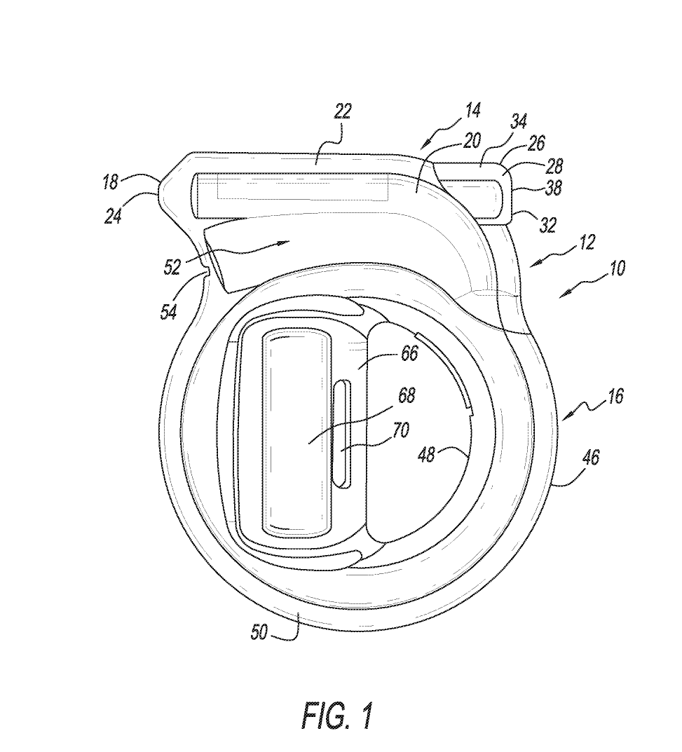

FIG. 2 is a side sectional view of a multi-purpose leash;

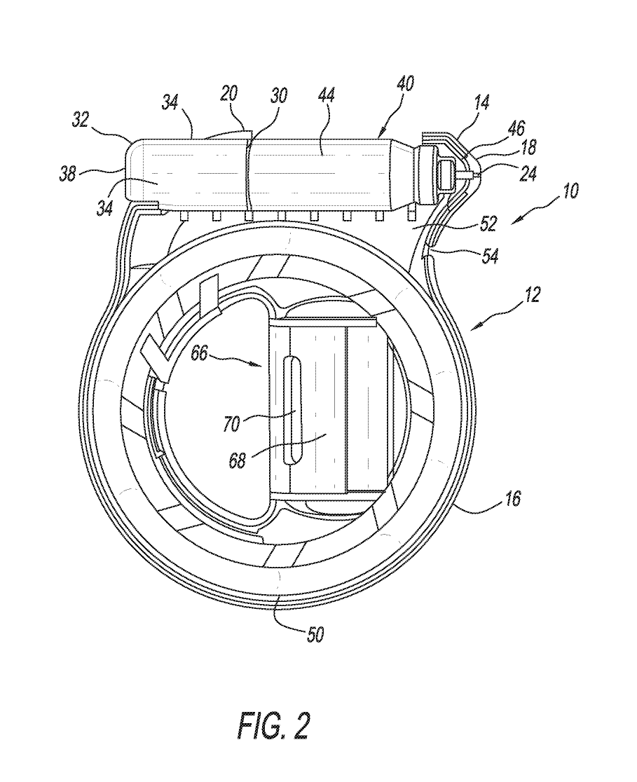

FIG. 3 is a sectional perspective view of a multi-purpose leash;

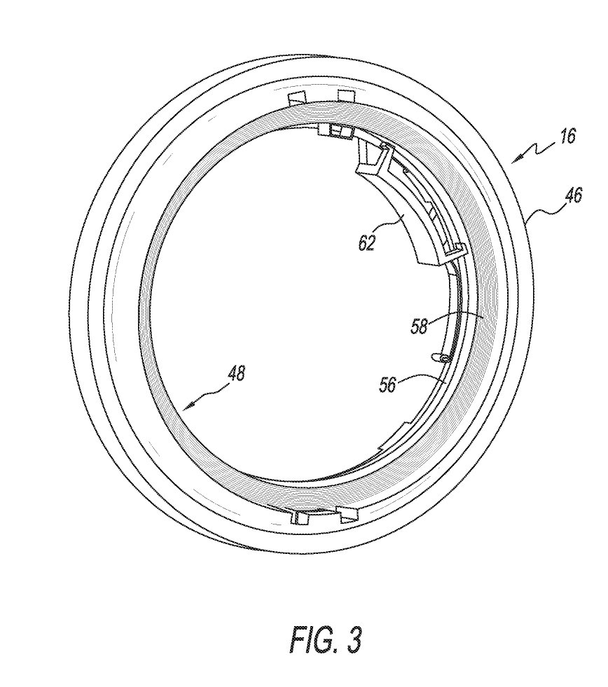

FIG. 4 is a side sectional view of a multi-purpose leash;

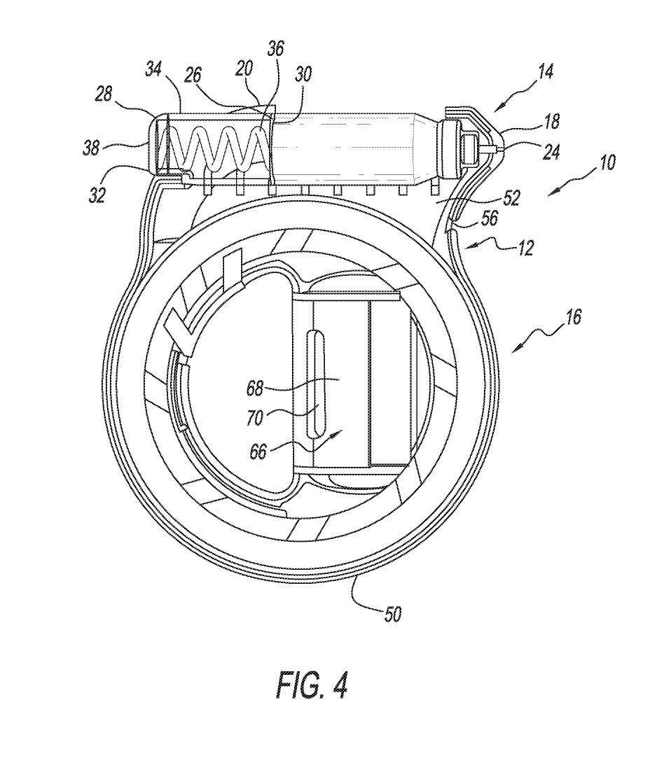

FIG. 5 is a side perspective view of a multi-purpose leash; and

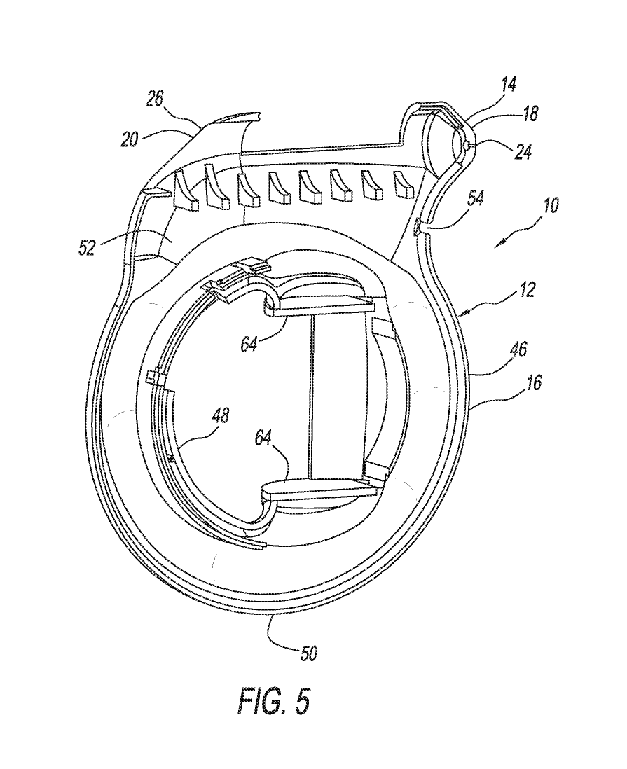

FIG. 6 is a side view of a multi-purpose leash.

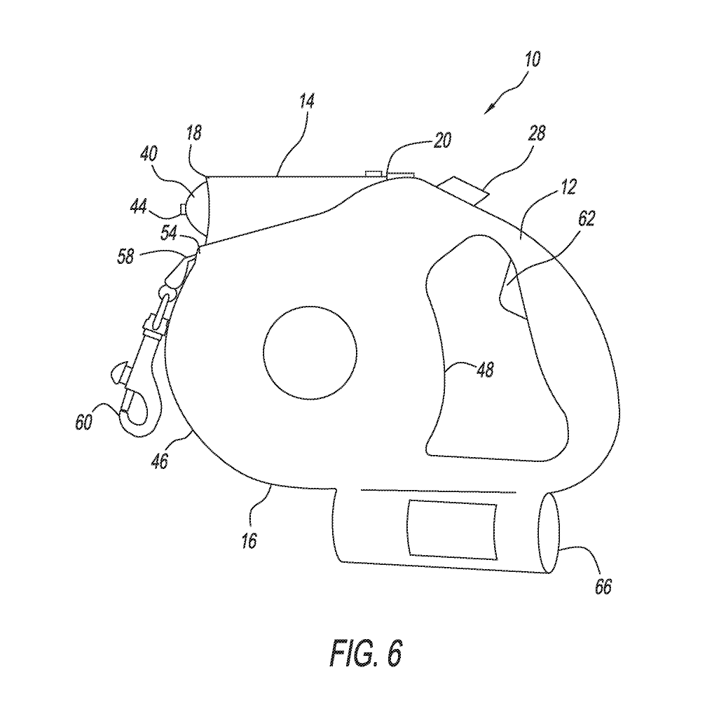

### DETAILED DESCRIPTION

Referring to the Figures, a self-defense leash 10 has a housing 12. While the housing is is of any size, shape, and structure, in one example shown, the housing 12 has an elongated top section 14, and a bottom circular bottom section 16.

The top section 14 is generally cylindrical with a first end 18, a second end 20, and a removable cover or door 22. The first end 18 is conical in shape with a central opening 24 at the apex. The second end 20 has an opening 26 adapted to receive a safety button 28. The safety button 28 has an open first end 30, a closed second end 32, a cylindrical sidewall 34 and a spring 36 disposed within the safety button 28. The second closed end 32 has a button cover 38 that is adapted to move toward the open end 30 when manual force is placed upon the cover 38. The top section 14 is formed to receive a spray canister 40 having a tank 42 and a nozzle 44 through the removable cover.

The spray canister 40 contains a defensive aerosol spray such as pepper spray or the like. The bottom section 16 has an outer edge 46 and an inner edge 48. The outer edge 46 has a lower arcuate portion 50 that terminates in a vertical connecting portion 52 to connect the top section 14 to the bottom section 16. Below and adjacent the central opening 24 on the first end 18 of the top section 14 is a leash opening 54 in the connecting portion 52.

Disposed within the bottom section 16 is a rotatable spring loaded spool 56 with a leash 58 wrapped about and attached to the spool 56. The leash 58 extends through the leash opening 54 and is attached to a clip 60.

On the inner edge 48 of the bottom section 16 is a leash control button 62. The leash control button extends through the inner edge 48 to selectively engage the spool 56 in a locked position.

The inner edge 48 is generally arcuate to form an ergonomic handle and terminates into two spaced apart and vertically aligned shoulders or ledges 64. Frictionally received between the ledges 65 is a bag spool 66. The bag spool 66 has a housing 68 with an elongated opening 70. Disposed within the housing 68 is a spool with a plurality of bags wrapped around the spool and extending out the elongated opening.

Alternatively, the housing 12 has a third section 72 below the bottom section 16 that contains a bag spool 66 adapted to dispense plastic bags for picking up animal waste.

In operation, the clip 60 is attached to an animal's collar. The leash control button 62 is moved to a release position which permits the spool to rotate under tension and the leash 58 to unwind permitting the animal to run at a comfortable distance away from the user. At any point the user can manually engage the leash control button 62 which prevents the leash 58 from unwinding further or rewind in the absence of an outward tension.

If the user encounters a dangerous or unwanted situation, the user can activate the defensive spray canister 40. To activate the canister 40 the user manually depresses the cover 38 of the safety button 28. The manual pressure compresses the spring 36 causing the canister 40 to move toward the central opening 24. As the canister 40 moves toward the central opening 24 the nozzle 44 is depressed releasing a defensive aerosol spray.

Accordingly, a multi-functional self-defense leash has been disclosed that at the very least meets all the stated objectives.

What is claimed is:

1. A multi-purpose leash, comprising:
a housing having a first section adapted to receive a spring canister and a second section adapted to receive a retractable leash; and
a safety button associated with the spray canister and adapted to selectively activate the spray canister.

2. The leash of claim 1 wherein the first section has openings at both ends and a removable cover in between both ends.

3. The leash of claim 1 wherein the safety button is connected to an end of the first section and has a compressible spring disposed within the safety button.

4. The leash of claim 1 wherein the leash is wrapped about a spring loaded spool and disposed within the second section of the housing.

5. The leash of claim 1 wherein the second section of the housing has a leash control button positioned to engage a spool within the second section and selectively prevent the spool from rotating.

6. The leash of claim 1 wherein a bag spool is connected to the second section of the housing.
